(19) United States
(12) Patent Application Publication
(10) Pub. No.: US 2012/0323809 A1
(43) Pub. Date: Dec. 20, 2012

(54) FOOD MANAGEMENT SYSTEM AND FOOD MANAGEMENT METHOD

(75) Inventor: Toshimi Fukui, Shiga (JP)

(73) Assignee: EMPIRE TECHNOLOGY DEVELOPMENT LLC, Wilmington, DE (US)

(21) Appl. No.: 13/386,505

(22) PCT Filed: Jun. 14, 2011
(86) PCT No.: PCT/JP11/03359

§ 371 Date: Jan. 23, 2012

(51) Int. Cl. G06Q 99/00

(52) U.S. Cl. 705/318

(57) ABSTRACT

A food product management system comprises a database configured to store data describing a plurality of relationships, each of the plurality of relationships defining a relationship between a producer, a food product, and a combination of stable isotopes, the food products being associated with the combinations of the stable isotopes that are different from producer to producer; a terminal device configured to receive results of an analysis of the combination of stable isotopes contained in one of the food products; and a management computer operatively connected to the database and the terminal device, and configured to receive the results of the analysis from the terminal device and to identify the producer of the one of the food products with reference to the database based on the results of the analysis.

### BACKGROUND

The public awareness of food safety has been increasing. Under such circumstances, some producers of food products attempt to improve quality of their products by raising animals with organic feed free of harmful chemical additives or by growing dietary plants without using pesticide chemicals, while other producers do not make such attempts. Accordingly, conscious consumers are careful about selecting a producer of a food product, and tracing the origin of a food product is becoming increasingly desirable.

On the other hand, in accordance with the increase of the public awareness of food safety, specialty food vendors sometimes need to verify the origin of their commercial products—for example, a coffee company tries to verify the origin of coffee beans. Further, the governments in various countries attempt to establish a system to ensure the food safety wherein the consumers can identify the origin of food products, using, for example, food labels.

However, once a food product enters the distribution process, it is very difficult to identify its origin. Although identifying the producer of a food product is sometimes possible by checking, for example, food labels or shipping tickets, it becomes impossible if there is an error or a fraud in such labels or tickets, or if the label is intentionally or accidentally removed.

### BRIEF DESCRIPTION OF DRAWINGS

FIG. 1 is a block diagram of an example of a food product management system arranged in accordance with present disclosure.

FIG. 2 is a schematic illustration of an example of a table showing data stored in a database that is arranged for a food management system in accordance with the present disclosure.

FIG. 3 is a block diagram illustrating an example of a computing device that is arranged for a food management system in accordance with the present disclosure.

FIG. 4 is a flow chart illustrating an example of a food management method in accordance with the present disclosure.

FIG. 5 is a flow chart explaining an example of a food management method in accordance with the present disclosure.

FIG. 6 is a flow chart explaining an example of a food management method in accordance with the present disclosure.

FIG. 7 is a flow chart explaining an example of a food management method in accordance with the present disclosure.

### DETAILED DESCRIPTION

In the following detailed description, reference is made to the accompanying drawings. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the drawings, can be arranged, substituted, combined, separated, and designed in a wide variety of different configurations, all of which are explicitly contemplated herein.

The present disclosure describes techniques, devices, apparatuses, systems, and methods for food management including, but not limited to, a food product management system including a database configured to store data of relationships between a producer, a food product, and a combination of stable isotopes; a terminal device configured to receive analysis results of the combination of stable isotopes contained in a food product; and a management computer configured to receive the analysis results from the terminal device and to identify the producer of the food products with reference to the database.

In one aspect, methods to confer an “isotopic bar code” to a food product are disclosed. Food products grown or raised at a particular location normally have a “natural” distribution of isotopes resulting from uptake of food precursors (such as grains or grass) and water. By providing food precursors and/or water having altered isotopic ratios, food products are prepared having “unnatural” isotopic ratios that are different from the “natural” isotopic ratios that would have been obtained from food products grown at the same particular location. When multiple site locations each produce food products having different and detectably distinct isotopic ratios, this effectively acts as a “bar code” or “label” that allows one to determine the particular site location from which the food product originated by detecting the isotopic ratio and comparing it against a database.

The stable isotopes contained in the combination of stable isotopes may be selected from, but not limited to, ¹³C, ¹⁵N, ¹⁷O, ¹⁸O, ²H, ⁴²Ca, ⁴³Ca, ⁴⁴Ca, and ⁴⁶Ca. The combination of stable isotopes may be indicated by delta value of each stable isotope or the ratio of delta values. The delta value of a stable isotope is calculated by the following formula:

Delta value=(Rₛₐₘₚₗₑ/R_{standard}−1)×1000 [per mil]

where and Rₛₐₘₚₗₑ and R_{standard} represent the molar ratios of the heavy (less common) to light (more common) isotope in the sample and in an international standard, respectively.

The concentration of stable isotopes contained in the combination of stable isotopes may be determined such that the concentration of one or more of the stable isotopes in the food product will be different from the naturally occurring local abundance. For example, the concentration of the isotope may be higher than the local abundance. For example, the concentration may be about twice to about ten times higher than the local natural abundance. Alternatively, the concentration can be higher than about ten times higher than the local natural abundance. The natural abundance of isotopes can vary from location to location. For example, the global natural abundance of major stable isotopes are shown below.

TABLE 1

| Stable isotope | Global natural abundance (%) |
|---|---|
| ²H | 0.015 |
| ¹³C | 1.1 |
| ¹⁵N | 0.36 |
| ¹⁷O | 0.038 |
| ¹⁸O | 0.20 |
| ⁴²Ca | 0.64 |
| ⁴³Ca | 0.13 |
| ⁴⁴Ca | 2.0 |
| ⁴⁶Ca | 0.004 |

For example, when ²H is contained in the combination of stable isotopes, the concentration of ²H in the combination may be determined so that ²H in the food product will be 0.030 to 0.15% in order to distinguish it from a naturally contained ²H abundance. The concentration of each stable isotope in the combination may be determined based on such range and how much the combination will be diluted when it is added to the food product.

Stable isotopes can be represented by an isotope ratio, or as a delta value. The isotope abundance can vary by geography. For example, the delta value of deuterium (²H) in water from central Texas (USA) can be 1 to 16, while the delta value of deuterium (²H) in water from coastal Oregon (USA) can be −95 to −80, and the delta value of deuterium (²H) in water from Montana (USA) can be −152 to −144. Local samples of food products grown or raised using naturally-occurring isotopes can be measured to determine a local natural abundance of the stable isotopes.

The combination of stable isotopes may contain any number of types of stable isotopes. If four types of stable isotopes (for example, ¹³C, ¹⁵N, ¹⁸O, and ²H) each at two concentrations are prepared, 2⁴=8 combinations of stable isotope would be obtained. Similarly, if four types of stable isotopes (for example, ¹³C, ¹⁵N, ¹⁸O, and ²H) each at five concentrations are prepared, 5⁴=625 combinations of stable isotopes would be obtained. The concentration of an isotope may be the same as the concentration of the same isotope that would be naturally contained in the food product. However, the combination of the stable isotopes may be selected to be distinct from the combination of stable isotopes that would be naturally contained in the food product.

The food product can generally be any type of food product. The food product is obtained from or prepared from an organism. For example, an apple is a food product obtained from an apple tree organism. Similarly, a chicken drumstick is a food product obtained from a chicken organism. The organism may be an animal, fish, shellfish, or plant, and thus the food product may be, but not limited to, meat including beef, pork, chicken, turkey, and so on; seafood including fish, shrimp, crabs, lobster, squid, octopus, clams, scallops, mussels, and so on; agricultural products including cereals (wheat, rice, corn, etc.), beans, and vegetables; the combination thereof. The organism may be processed to obtain the food product after being fed with the food precursor containing the combination of stable isotopes. The food precursor may be a feed stuff, a fertilizer, or water. The food product may be a “whole food product” such as eggs, beef steak, chicken breasts, fish fillets, whole fruit, whole vegetables, whole grains, rice, and so on. Alternatively, the food product may be a “processed food product” such as ground beef, ground pork, ground chicken, ground turkey, sausage, “chicken nuggets”, fish paste, ground shrimp, tofu, soymilk, applesauce, fruit juice, and so on. The processed food product can include food products from one organism or from two or more organisms.

For a processed food product, its isotopic bar code can be determined after the processed food product is prepared. The isotopic bar code will reflect the isotopic bar codes of the individual food products that went into the processed food product. For example, ground chicken can be prepared from a number of chickens, and the isotopic bar code can be determined by analyzing the ground chicken processed food product. Information regarding the ground chicken, such as the identity of the processed food product, its isotopic ratio(s), source location, date, and so on can be entered into a database in the same manner as information regarding a whole food product.

In some cases, the isotopic bar code can be used to identify the source of a particular food product. In other cases, a food producer can use an isotopic bar code to not only identify the source of the food product, but also to identify the particular lot, batch, harvest, or time that the food product was prepared. In these situations, the food producer can have each set of food products that have a detectably different isotopic bar code. An interested party can subsequently analyze the food product, and determine both the source of the food product, and the particular lot, batch, harvest, or time that the food product was prepared.

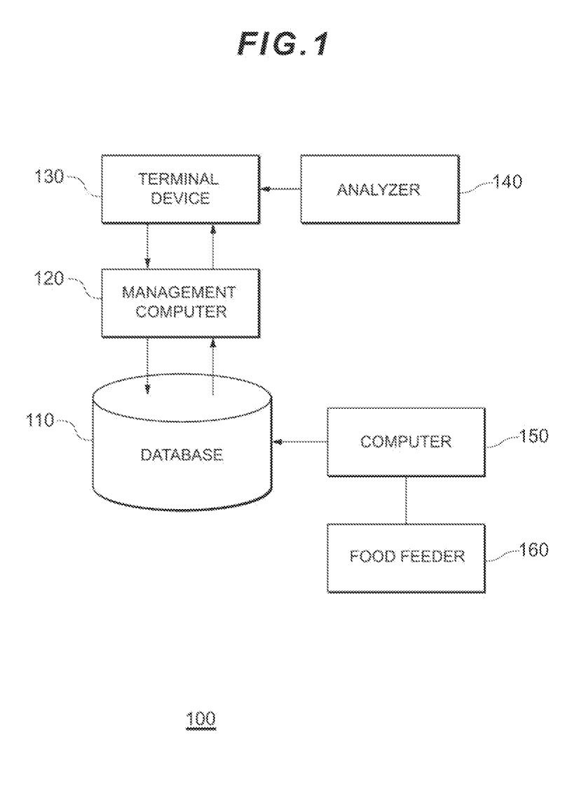

FIG. 1 is a block diagram of an example of a food product management system arranged in accordance with the present disclosure. Referring to FIG. 1, a food product management system 100 may include at least a database 110, a management computer 120 and a terminal device 130.

The database 110 may be configured to store and manage data describing a plurality of relationships each defining a relationship between a producer, a food product, and a combination of stable isotopes. In other words, each data set explains which combination(s) of stable isotopes is used by which producer for what food product. Such data may be given by a producer of a food product. The producer of the food product can enter data directly into a computer or database, or may have the information sent on their behalf to a database administrator. The data may also be given by a party, such as a government agency or an agricultural cooperative, that configures a food management system and authorizes the producer to use a specific combination of stable isotopes. The database 110 may be operatively connected to the management computer 120 via a network such as a LAN, a WAN, and/or the Internet. The database 110 may also be connected to a computer 150 which may be used to store the data in the database 110. The database may be configured as a part of the management computer 120 as will be discussed below. The terminal device 130 may be configured to receive a result of an analysis of the combination of stable isotopes contained in a food product, the analysis being conducted and input by an individual or party that desires to identify or verify the producer of the food product. The individual or party may include, but not limited to, a consumer, a consumer organization, a retailer, a specialty food vendor, a government agency, or a testing company (hereinafter referred to as the “Analyzers”). The terminal device 130 may be configure as a part of the management computer 120.

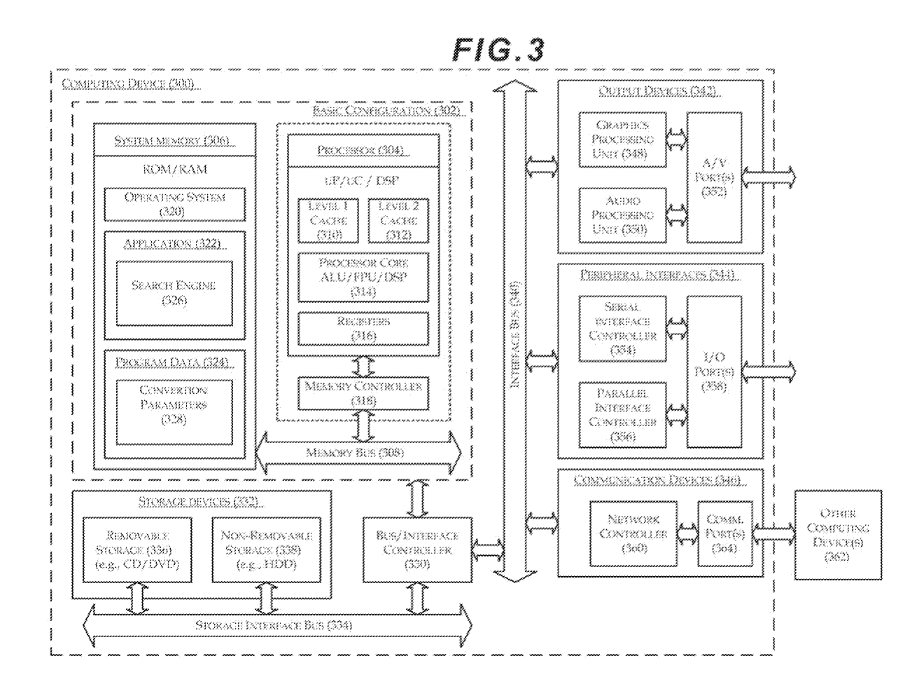

The management computer 120 may be configured to receive the analysis result, i.e., the combination of stable isotopes contained in the food product, from the terminal device 130, and convert the analysis result into data that is comparable with the data stored in the database 110, if necessary. The management computer 120 may be configured to compare the analysis result or the converted data with data in the database 110 to identify the producer of the food product. An example of a configuration of the management computer 120 will be discussed with reference to FIG. 3).

The food product management system 100 may further include an analyzer 140 configured to conduct the analysis described above. The analyzer 140 may be configured to analyze a food product to determine the combination of stable isotopes contained in the food product and to send the result of the analysis to the terminal device 130. The analyzer 140 may be, but not limited to, a GC-MS device. The analyzer 140 may be configured to determine the type of stable isotopes contained in the combination of stable isotopes and a ratio of the stable isotopes.

The producer of a food product may be an individual or party that directly or indirectly grows an organism from which the food product is made. Examples of the producer may include, but not limited to, a farmer, a breeder, a grower, a farm, an aquafarm, an agricultural cooperative. Combinations of stable isotopes differ from producer to producer, in other words, each producer has its own specific combination(s) of stable isotopes.

The food product management system 100 may further include a food feeder 160. The food feeder 160 may be configured to feed a food precursor containing a predetermined combination of stable isotopes to an organism from which the food product is made. The food feeder 160 may be configured to label the food precursor with the predetermined combination of stable isotopes before feeding the food precursor to the organism. The computer 150 may be configured to send to the database the information of the combination of stable isotopes that should be used for the labeling of the food precursor.

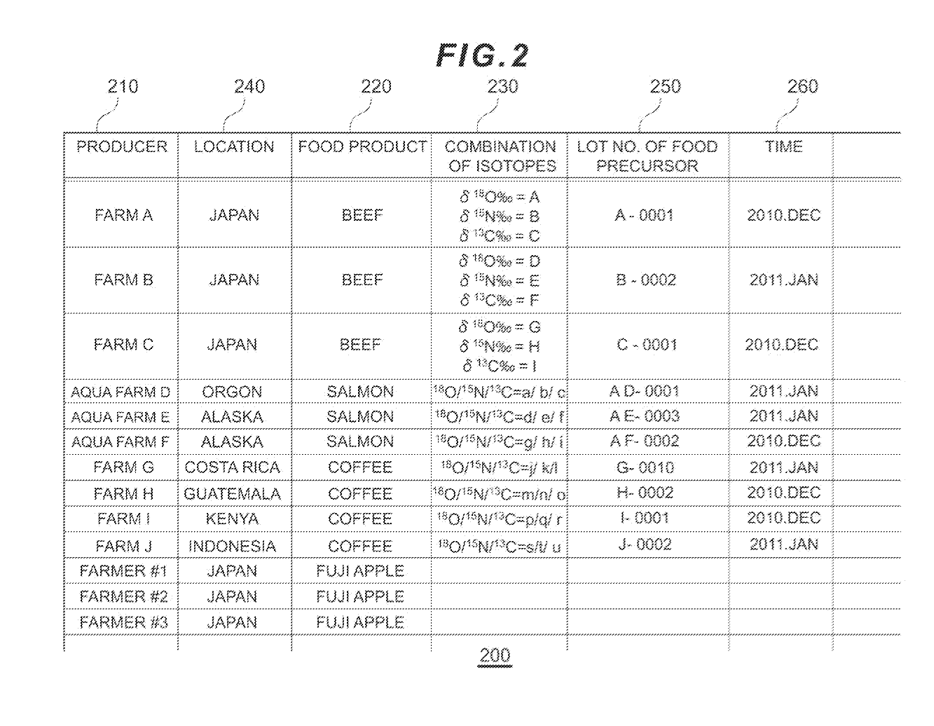

FIG. 2 is a schematic illustration of an example of a table showing the data stored in the database 110. As shown in FIG. 2, a table 200 may include fields for at least a producer 210, a food product 220, and a combination of stable isotopes 230, and may associate each producer and a combination of the stable isotopes to a corresponding food product. The combination of stable isotopes in the filed 230 may be indicated by a delta value (as shown in the line “Farm A”) or a ratio of delta values (as shown in the lines “Farm B” and “Farm C”).

The table 200 may further include fields for other information of the food product including, but not limited to, a location 240 of the producer, a production lot of the food precursor 250, and time 260. The time in the filed 260 may be the time, for example, when the food precursor is fed to the organism, or when the food product is produced from the organism.

FIG. 3 is a block diagram illustrating an example computing device 300 that is arranged for food product management system in accordance with the present disclosure. The computing device 300 may be adapted for the management computer 120 and the computer 150. In a very basic configuration 302, computing device 300 typically includes one or more processors 304 and a system memory 306. A memory bus 308 may be used for communicating between processor 304 and system memory 306.

Depending on the desired configuration, processor 304 may be of any type including but not limited to a microprocessor (uP), a microcontroller (uC), a digital signal processor (DSP), or any combination thereof. Processor 304 may include one more levels of caching, such as a level one cache 310 and a level two cache 312, a processor core 314, and registers 316. An example processor core 314 may include an arithmetic logic unit (ALU), a floating point unit (ITU), a digital signal processing core (DSP Core), or any combination thereof. An example memory controller 318 may also be used with processor 304, or in some implementations memory controller 318 may be an internal part of processor 304.

Depending on the desired configuration, system memory 306 may be of any type including but not limited to volatile memory (such as RAM), non-volatile memory, (such as ROM, flash memory, etc.) or any combination thereof. System memory 306 may include an operating system 320, one or more applications 322, and program data 324. Application 322 may include, for example, a search engine 326 that is arranged to identify a producer of a food product with reference to the database 110 based on a result of an analysis of the combination of stable isotopes contained in a food product. Program data 324 may include, for example, a conversion parameters 328 that may be useful for conversion of the analysis result into data that is comparable with the data stored in the database 110 as is described herein. For example, when the data of a combination of stable isotopes is stored as delta values in the database 110, the conversion parameters are used to calculate delta values from the molar ratio Rₛₐₘₚₗₑ and R_{standard} provided as analysis results. Further, program data 324 may include access control data used for authorizing an user to access the database 110. In some embodiments, application 322 may be arranged to operate with program data 324 on operating system 320 such that the search engine 326 accesses the database 110 to identify a producer of a food product. This described basic configuration 302 is illustrated in FIG. 3 by those components within the inner dashed line.

Computing device 300 may have additional features or functionality, and additional interfaces to facilitate communications between basic configuration 302 and any required devices and interfaces. For example, a bus/interface controller 330 may be used to facilitate communications between basic configuration 302 and one or more data storage devices 332 via a storage interface bus 334. Data storage devices 332 may be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 306, removable storage devices 336 and non-removable storage devices 338 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 300. Any such computer storage media may be part of computing device 300.

Computing device 300 may also include an interface bus 340 for facilitating communication from various interface devices (e.g., output devices 342, peripheral interfaces 344, and communication devices 346) to basic configuration 302 via bus/interface controller 330. Example output devices 342 include a graphics processing unit 348 and an audio processing unit 350, which may be configured to communicate to various external devices such as a display or speakers via one or more A/V ports 352. Example peripheral interfaces 344 include a serial interface controller 354 or a parallel interface controller 356, which may be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which may be arranged to facilitate communications with one or more other computing devices 362 over a network communication link via one or more communication ports 364.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RE), microwave, infrared (IR) and other wireless media. The term computer readable media as used herein may include both storage media and communication media.

Computing device 300 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 300 may also be implemented as a personal computer including both laptop computer and non-laptop computer configurations.

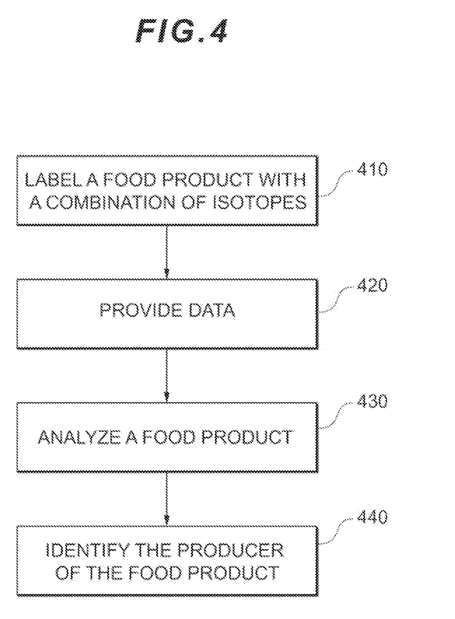

FIG. 4 is a flow chart explaining an example of a food management method arranged in accordance with the present disclosure. Referring to FIG. 4, a food product is labeled with a combination of stable isotopes that differ from producer to producer (block 410). The food product may be labeled by feeding one or more food precursors each containing the combination of stable isotopes to an organism from which the food product is made. The combination of stable isotopes may be determined by the producer, or by a government agency or an agricultural cooperative that runs the system 100. In a case where the organism is an animal or fish, the food precursor containing the combination of stable isotopes ma be manufactured by, for example, simply mixing a common feedstuff or water with a compound labeled with stable isotopes, such as H₂¹⁷O, D₂O, ¹³C-labeled carbon compound, and organic and inorganic compounds containing ¹⁵N. The stable isotopes of carbon, hydrogen, nitrogen or oxygen in the food precursor would be incorporated into flesh or body fluid in the organism. The stable isotopes of phosphorus or calcium would be incorporated into bone tissue in the organism. In a case where the organism is a plant, the food precursor may be H₂¹⁷O and a fertilizer labeled with ¹⁵N. The plant may be labeled by feeding the ⁴²Ca, H₂¹⁷O and/or ¹⁵N-labeled fertilizer. Labeling may be performed by the food feeder 160.

Next, data which describes a plurality of relationships each defining a relationship between a producer, a food product, and a combination of stable isotopes is stored in the database 110 (block 420). This may also be performed by a computer managed by a producer of the food product, a government agency, an agricultural cooperative and the like.

When the producer of a food product needs to be identified, a combination of stable isotopes contained in a food product is analyzed (block 430). The analysis may be performed using the analyzer 140 by the Producers, Analyzers, or the company that is commissioned to conduct an analysis of a food product by the Producers or Analyzers. The analysis result may be indicated by a delta value of each stable isotope or the ratio of delta values.

Next, the producer of the food product is identified with reference to the database 110, based on the analysis result obtained in block 430 (block 440). This identification may be performed by the management computer 120 managed by an individual or party such as, for example, a consumer or a consumer organization that has an interest in the origin of a food product; a retailer or a specialty food vendor that needs to verify the origin of a commercial product; a government agency in charge of ensuring food safety; or a testing company. The analysis result may be input to the terminal device 130 by the individual or party, and the terminal device 130 may send the analysis result to the management computer 120. The management computer 120 may compare the analysis result with data stored in the database 110 to identify the producer that produces a food product containing the same combination of stable isotopes as the analysis results.

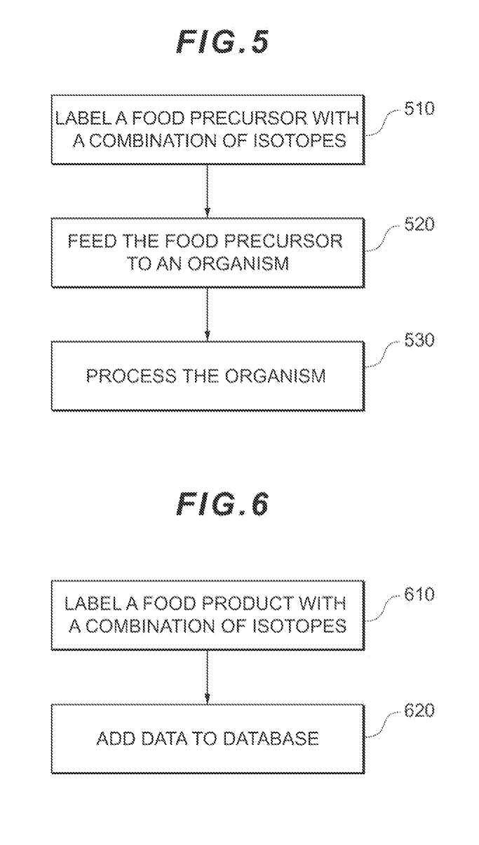

FIG. 5 is a flow chart explaining an example of a food management method arranged in accordance with the present disclosure. This example method may be performed by a producer of a food product. For example, a breeder of cows from which famous beef is produced may perform this method so that the origin of the beef can be traced in the future by an individual or a party that has an interest in the origin of the beef. A food precursor for organisms may be labeled with a combination of stable isotopes by the computer 150 managed by a producer of the food precursor, the combination being used only by the producer (block 510). An organism is then fed the food precursor by the food feeder 160 (block 520) and processed to obtain a food product containing the combination of stable isotopes (block 530). The obtained food product may be analyzed to identify the producer after it enters the distribution process.

An organism can be fed with at least one food precursor for a period of time for the organism to develop stable isotopic ratios in its tissues (e.g., plant cell walls, bones, fat, muscles, and so on). After harvesting of the organism and preparing the food product, the isotopic ratios will be retained and can be detected at a later date.

Alternatively, the time when the organism is fed with the food precursor may be determined based on the half-life in blood of the stable isotopes contained in the food precursor. The half-life of a stable isotope in blood is typically shorter than the half-life of the stable isotope in air. In consideration of the time period from the feeding to the analysis, the computer 150 may be configured to feed the organism with the food precursor at appropriate time so that the remaining stable isotope in the food product is detectable. For example, the half-life of a stable isotope in cow blood is about 140 days. Accordingly, a food precursor may be fed to a cow within four months before being processed.

FIG. 6 is a flow chart explaining an example of a food management method arranged in accordance with the present disclosure. This example method may also be performed by a producer of a food product. When a food product is labeled at a location of a producer with a combination of stable isotopes that would not naturally occur in the food products at the location (block 610), data describing a relationship between the location, producer, combination of stable isotopes, and food product is added to the database 110 (block 620). The addition of the data to the database 110 may be performed by sending the data to the database 110 via the computer 150.

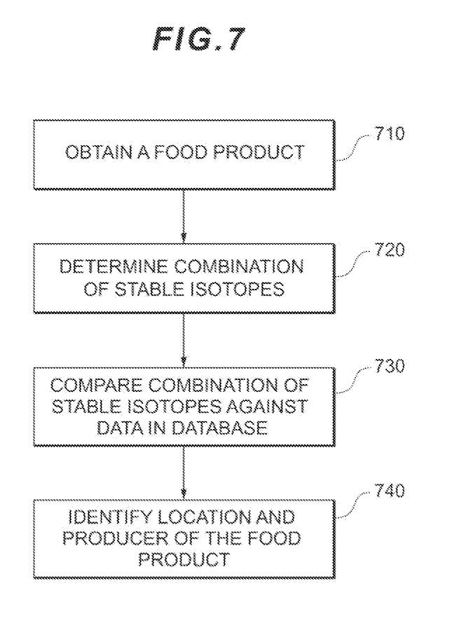

FIG. 7 is a flow chart explaining an example of a food management method arranged in accordance with the present disclosure. The example method may be performed by an individual or party such as the Analyzers. In this method, a food product is obtained by an individual or party (block 710) and the combination of stable isotopes in the food product may be determined by the analyzer 140 (block 720). The terminal device may then receive the determined combination of stable isotopes and send the combination data to the management computer 120. The management computer 120 may compare the determined combination with data contained in the database 110 (block 730), and identify the location and producer that provides a food product containing the same combination of stable isotopes as the determined combination.

### EXAMPLES

### Example 1

### Growing Apples with Different Isotopic Ratios

Three farmers each having nearby farms can grow Fuji apples using nitrogen-based fertilizers. Farmer #1 can use an ammonium nitrate fertilizer having a high ratio of ¹⁵N; farmer #2 can use an ammonium nitrate fertilizer having a medium ratio of ¹⁵N; and farmer #3 can use an ammonium nitrate fertilizer having a low ratio of ¹⁵N. The fertilizer can be applied directly to the soil, or can be added to irrigation water. The fertilizers can be used consistently over the growing season according to normal farming practices. Each farmer can harvest apples from their farms. The apples can visually appear identical, and can be impossible for a consumer to identify the particular farm from which the apples were harvested.

Each of the three farmers can have the isotopic ratio of their apples measured, and the ratio and farm location can be entered into a database.

At a later date after the apples have been delivered into the marketplace, an interested party (such as a consumer or government agency) can have a particular apple's isotopic ratio measured, and compared against the database. By cross-referencing the isotopic ratio and the farm location, the interested party can easily determine the original farm that grew the apple.

### Example 2

### Tracking Sources of Contaminated Vegetable Products

After a large number of consumers have become sick with bacteria ingested from contaminated eggplant vegetables, a government testing agency can determine the isotopic ratios of the contaminated eggplant, and can compare the ratios against a database of farms. If the determined isotopic ratios match a particular farm, then the government agency can immediately contact the farm to determine how the bacterial contamination occurred. Alternatively, if the determined isotopic ratios do not match any of the farms listed in the database, then the listed farms could not have been the source of the contaminated vegetables.

### Example 3

### Tracking Sources of Contaminated Meat Products

After a large number of consumers have become sick with bacteria ingested from contaminated beef, a government testing agency can determine the isotopic ratios of the contaminated beef, and can compare the ratios against a database of farms. If the determined isotopic ratios match a particular farm, then the government agency can immediately contact the farm and processing facility to determine how the bacterial contamination occurred. Alternatively, if the determined isotopic ratios do not match any of the farms listed in the database, then the listed farms could not have been the source of the contaminated vegetables.

### Example 4

### Verifying Single Origin Coffee

A specialty coffee company can contract with a particular coffee grower to provide “single origin” estate coffee beans grown only at a particular location. The specialty coffee company and its customers will typically pay a premium price for the estate coffee beans, and would prefer to have some level of assurance that the purchased coffee beans in fact came from the one particular location. As coffee beans generally visually look similar to other coffee beans, this can be a challenging goal.

The particular coffee grower can use fertilizer having a specific isotope ratio of ¹³C, ¹⁵N, and ¹⁸O to grow the coffee beans, such that the harvested coffee beans will have a stable isotope ratio that is different from beans grown with conventional fertilizer. The coffee grower can analyze the harvested coffee beans, and can report the isotope ratio to the specialty coffee company. At any time, the specialty coffee company will be able to test samples of coffee beans shipped from the coffee grower to verify that they, are purchasing the correct coffee beans obtained from the single coffee plantation.

### Example 5

### Identifying Source and Batch of Soybeans and Soybean Products

A farm can use fertilizer having specific isotope ratio of ¹³C, ¹⁵N, and ¹⁸O to grow soybeans. At the end of each harvest cycle (about 3-4 months), a fertilizer having a different specific isotope ratio can be used, such that successive crop harvests will each have its own different isotopic ratios. The farm identity, harvest-specific isotopic ratios, and date of each harvest will be entered into a database.

While the invention has been described with respect to a limited number of embodiments, those skilled in the art having benefit of this disclosure, will appreciate that other embodiments can be devised which do not depart from the scope of the invention as disclosed herein. Accordingly, the scope of the invention should be limited only by the attached claims.

1-25. (canceled)

26. A food product management method comprising:
obtaining a food product labeled with a combination of stable isotopes, wherein the combination of stable isotopes is selected to be distinct from a combination of stable isotopes that would be naturally contained in the food products;
determining the combination of stable isotopes in the food product;
comparing the combination of stable isotopes against data contained in a database, where the data describes relationships between locations, producers, combinations of stable isotopes, and food products; and
identifying the location and producer of the food product.

27. The food product management method according to claim 26, wherein a stable isotope contained in the combination of stable isotopes is selected from the group consisting of ¹³C, ¹⁵N, ¹⁷O, ¹⁸O, ²H, ⁴²Ca, ⁴³Ca, ⁴⁴Ca, and ⁴⁶Ca.

28. The food product management method according to claim 26, wherein the food products are or are prepared from animals, fish, or plants.

29. A food product management method comprising:
obtaining a contaminated food product labeled with a combination of stable isotopes, wherein the combination of stable isotopes is selected to be distinct from a combination of stable isotopes that would be naturally contained in the food product;
determining the combination of stable isotopes in the contaminated food product;
comparing the combination of stable isotopes against data contained in a database, wherein the data describes one or more relationships between at least producers, combinations of stable isotopes and food products;
identifying the location and producer of the contaminated food product; and
contacting the producer of the contaminated food product.

30. The method of claim 29, wherein contacting the producer of the contaminated food product comprises contacting the producer to determine how contamination of the food product occurred.

31. The method of claim 29, wherein contacting the producer of the contaminated food product comprises contacting the producer to halt production of the contaminated food product by the producer.

32. A food product management method comprising:
obtaining a food product labeled with a combination of one or more stable isotopes, wherein the combination of stable isotopes is selected to be distinct from a combination of stable isotopes that would be naturally contained in the food product;
determining the combination of stable isotopes in the food product;
determining a time when the food product last received the combination of stable isotopes;
comparing the combination of stable isotopes against data contained in a database, wherein the data describes one or more relationships between at least producers, combinations of stable isotopes and food products; and
identifying the location and producer of the contaminated food product based on the data contained in the database, the time when the food product last received the combination of stable isotopes, and a half-life for each of the one or more stable isotopes.

33. The food product management method according to claim 32, wherein a stable isotope contained in the combination of stable isotopes is selected from the group consisting of ¹³C, ¹⁵N, ¹⁷O, ¹⁸O, ²H, ⁴²Ca, ⁴³Ca, ⁴⁴Ca, and ⁴⁶Ca.

34. The food product management method according to claim 32, wherein the food products are or are prepared from animals, fish, or plants.

35. A food product management method comprising:
labeling a food product at a location of a producer with a combination of stable isotopes that would not naturally occur in the food product and uniquely identifies the food product based on the producer, a type of food product and the location; and
adding data to a database, wherein the data describes the relationship between the location, the producer, combination of stable isotopes and the food product.

36. The food product management method according to claim 35, wherein labeling the food product further uniquely identifies the time at which the food product was produced, and wherein adding data to the database further comprises adding data that describes the time at which the food product was produced.

37. The food product management method according to claim 36, further comprising:
comparing the combination of stable isotopes against the data; and
identifying the location and producer of the food product based on the data, the time at which the food product was produced, and a half-life for each of the one or more stable isotopes.

38. The food product management method according to claim 35, wherein a stable isotope contained in the combination of stable isotopes is selected from the group consisting of ¹³C, ¹⁵N, ¹⁷O, ¹⁸O, ²H, ⁴²Ca, ⁴³Ca, ⁴⁴Ca, and ⁴⁶Ca.

39. The food product management method according to claim 35, wherein the food products are or are prepared from animals, fish, or plants.
